(19) United States
(12) Patent Application Publication
(10) Pub. No.: US 2013/0119297 A1
(43) Pub. Date: May 16, 2013

(54) MAGNETICALLY SUSCEPTIBLE CONDUCTIVE SLURRY

(71) Applicant: Russell Byron Auger, Chicago, IL (US)

(72) Inventor: Russell Byron Auger, Chicago, IL (US)

(21) Appl. No.: 13/294,178

(22) Filed: Nov. 11, 2011

(51) Int. Cl. H01F 1/28; H01F 1/40; H01B 1/00

(52) U.S. Cl. 252/62.55; 252/62.51 R

(57) ABSTRACT

A magnetically susceptible conductive slurry (MSCS) is comprised of magnetically susceptible granules in a conducting fluid mixture. The material properties of a MSCS act in a single or combination of methods for conduction, transportation, reflection and spallation of elementary particles and composite particles as found in physics. The two main components of an MSCS are magnetically susceptible granules to which a fluid adheres that as a composition act in a linear or non-linear manner to conduct elementary particles between terminals. Magnetically susceptible granules that are not normally wet by a conducting fluid are encapsulated and coated by a wetting material that increases the adhesive forces of the material fluid interface above that of the fluid's cohesive forces. A MSCS is susceptible to magnetic fields and is capable of being shape formed during fabrication and use.

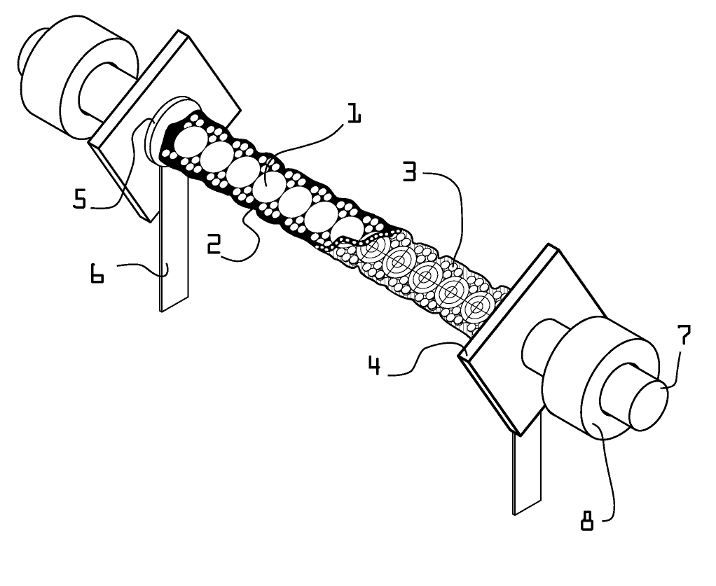

### TECHNICAL FIELD

The field of this invention relates to a composite material that can be magnetically shape formed and acts in a single or combination of methods including conduction, reflection and spallation of elementary particles and composite particles as found in physics through or away from three dimensional volumes. The invention further relates to material properties that describe localizing and orienting semiconducting devices to generate linear and non-linear electrical waves.

### STATE OF THE ART

The use of elementary particles as found in physics is the current foundation of power transmission and storage systems. Those skilled in the art of using elementary particles and composite particles as found in physics use particular particles from the lepton, quark and boson families where at this point in time it is a member of the lepton family the electron, that currently dominates the electronics and energy distribution industries. There are many materials capable of transporting or conducting elementary particles and their properties oftentimes overlap. A material that conducts bosons is Deuterium and as claimed by inventors includes electrical conduction by transport of charged ions and is excited by photons. Long term storage of energy product is currently dominated by the nuclear industry, where transmutation of atoms from nuclear waste product by spallation produces viable nuclear power product.

### BACKGROUND

A MSCS is comprised of magnetically susceptible granules immersed in a conductive fluid. As such a MSCS is the antithesis of a ferrofluid where a ferrofluid includes ferrous granules enmeshed in a dielectric oil and a MSCS is a dispersion of granules in a conducting fluid. The first ferrofluid was produced in 1966 using a ferromagnetic cobalt granule as disclosed in U.S. Pat. No. 3,228,882. Subsequent ferrofluids disclosed in U.S. Pat. No. 4,381,244, use smaller granules and different magnetic material such as ferrous oxide (Fe₃O₄) immersed and enmeshed within a dielectric oil. Both types of ferrofluids require a dielectric polymer to separate mesoscopic granules thereby reducing granule aggregation as typically occurs by gravitational sedimentation and by magnetic force. This invention, the MSCS discloses a method of encapsulation or coating as one method of separating and preventing uncontrolled assembly or aggregation by magnetically susceptible granules.

The ability of a MSCS to form, reform and manipulate conductors and computational elements as a slurry offers significant advance. A number of applications that benefit from the invention of this material include multi-switches, insulated and fused electronics, three dimensional printed circuit boards, dynamic mirrors, lenses, light pipes, recycled actinide fuel cells and biological shielding.

Electrical conductors typically incorporate an insulator surrounding a conducting element. The most effective method of electrical insulation is a vacuum as disclosed by Thomas Edison in U.S. Pat. No. 239,745. Edison and other inventors as disclosed in U.S. Pat. No. 3,657,467, found that the ability to keep a core conductor cool increases both performance and lifespan of an electrical device. Insulating a solid core conductor may include the use of an insulating bead strung along a length of the core conductor as disclosed in U.S. Pat. No. 2,931,852. Additional perturbations for insulating electrical components include polymers and mesoscopic insulators where one patent uses a vertically oriented ball float as disclosed in U.S. Pat. No. 6,180,873. The patent relies upon gravitational orientation to force a ball against a conductor, thereby displacing the insulator and closing the circuit.

At present varying the length and diameter of a conductor is the most efficient method of connecting devices from integrated circuits to power supply lines. Varying the length of a conducting member as disclosed in U.S. Pat. No. 4,116,153 includes both a torsional member and a reel to vary either the diameter or length of the conducting member. A MSCS, improves upon such a method of varying conductor length by dimensionally changing volumetric shape of a conductor. The most compact, economical system for connecting circuits is the printed circuit board (PCB) which currently involves two and three dimensional integration of circuits the limitations of which include fixed localization of semiconductor devices. Forming wire and harness connectors includes consecutive bar stock milling, welding of metallic powders and epoxy resin impregnated powders. Two such examples of powder technology in the PCB industry include welding by thermal fusing of metal granules as disclosed in U.S. Pat. No. 6,499,217 and high-pressure forming by powders as disclosed in U.S. Pat. No. 7,237,330. Both of these methods of forming PCB traces include direct application onto a structural insulating material such as fiberglass and the final product cannot be modified nor repaired for the cost of a newly manufactured item.

Failure of PCB traces includes damage by vaporization induced by electrical spark or arc. Repairing PCB damage is possible with electrically conductive paints designed for fabricating circuit boards as disclosed in U.S. Pat. No. 3,015,632, U.S. Pat. No. 4,369,269 and U.S. Pat. No. 4,696,764. Repairing such electrical defects is labor intense while locating damage is time consuming and not possible for some sub-micron circuitry. Resin and powder metal composite include a high percentage of liquid insulator separating metal particles through which current must travel, compounding failure. The ability of electrical conductors to self heal is suggested as disclosed in U.S. Pat. No. 7,666,503 and offers a solution for repairing the insulating member, but repair of the core electrical conductor has not yet been fully addressed. The improvement of a MSCS is realized by rapid re-forming of conductor and shielding members. The ability to rapidly disconnect and re form traces using magnetic forming increases the speed and reliability of devices using a MSCS. The benefit of magnetic forming includes elimination of defects within a segment of materials by magnetic compression during stirring as disclosed in U.S. Pat. No. 4,527,615. A MSCS material may be magnetically formed into conducting channels and has the ability to self heal or reform as desired.

The formation of three dimensional PCBs requires socket or pad to form a reduced footprint. Integrated circuits are placed in variable geometries and comprised of mixed metallurgical pads as disclosed in U.S. Pat. No. 6,931,722 to prepare an insulating member for an integrated circuit. In a slurry form, metal pads may be inessential for all applications when insulated semiconductor devices are incorporated into a MSCS slurry or liquid wire. The MSCS allows three dimensional placement within a volume as an improvement. In addition, the potential to check and remove defective elements increases longevity and utility.

A utility of an MSCS is the incorporation of a pre actinide element or isotopes within granules to harness the process of transmutation. A patent that includes discussion of transmutation of nuclear wastes is disclosed in U.S. Pat. No. 5,160,696. The ability to convert uranium waste into plutonium occurs by exposure to increased neutron flux or spallation by proton or neutron beams providing a way to recycle nuclear reactor fuel. The first step in this process typically involves forming a uranium salt and then packing it into a three dimensional matrix. In this instance the neutron flux density required to transmute the material is increased as the distribution matrix of uranium increases. Typically processing is expensive and requires a substantial amount of time and energy to complete, upwards of two years. When exposed to an equivalently accelerated particle beam a MSCS inclusive of actinide isotope where the nuclide matrix is reduced will have increased flux density of proton and neutrons for a reduced statistical time to transmutation.

Understanding flow of a dispersion is important for the purposes of shape forming. In geology, granules within a fluid contribute to the viscosity of the composite dispersion. Factors that contribute to changes in fluid viscosity include the volume fraction of granules, their respective size, shape orientation and rotational energy in solution. Total viscosity can be estimated through a summation of these variables and higher order terms. Those skilled in the art of magnetohydrodynamic (MHD) forming a MSCS will be able to calculate the viscosity during thickening which parallels impulse of thixotropic fluid by way of concentrating magnetic material.

### DETAILED DESCRIPTION OF THE DRAWING

The drawing depicts a volume of simple conducting MSCS held in place by an electromagnetic field using a specific assembly to describe material properties of the invention. In an environment void of a significant magnetic field the MSCS will fill the dimensions of a container to shape in the fluid state.

The drawing shows a cross section of MSCS comprised of large magnetically susceptible granules [1] that act as a conductor and small magnetically susceptible granules [3] manufactured to be either a conducting or insulating member. Both types of granules are used to hold a volume of non-magnetic conducting fluid [2] within a magnetic field. In this instance all granules are comprised of a magnetically susceptible material, are spherical in shape and have a complete surface treatment to fully encapsulate them. Granules are also coated in a wetting material that allows them to wet with a conducting fluid. When fully mixed this MSCS combines the three members [1], [2] and [3] as a MSCS that is used to conduct electrons. During use the slurry is magnetically formed and used by terminal members [4-8] that are necessary to describe basic functional properties of the MSCS. Two terminal type end-caps [4] are equipped with gold-plated cylindrical electrical pads [5] with flat electrical traces [6] on the proximally facing surfaces. A magnetic field is generated by two single pole opposing magnets [7] perpendicularly aligned along the same magnetic field vector of opposite electrical pads magneto mechanically holding a variable length, fixed volume of MSCS to close a simple electrical circuit. This entire assembly [1-8] may be inserted into a square tube with end-caps separated by a variable distance to protect the investigator. Applying a voltage across a closed circuit produces a Hall effect. A disengaged circuit, held open, is one with two like magnet poles facing each other. A volume of MSCS can be drawn out into fine liquid wire between terminals or pushed together to produce a short thick plug of slurry. The large diameter muti-pole magnets [8] are used to hold plural conducting volumes of MSCS between the two terminals thereby increasing the conducting capacity.

### DETAILED DESCRIPTION OF THE INVENTION

The current invention relates a novel MSCS used to form connections for conduction, transportation, reflection, spallation, or combination thereof, of elementary particles as found in physics. As such one function of this material is to form lengths of connections or liquid wires that are easily formed or repaired. This invention also relates additional material properties including integrated semiconductor devices to simulate functions of electronics devices in three dimensional dynamic configurations.

A MSCS is comprised of magnetically susceptible granules immersed in a conductive fluid. A three dimensional magnetically susceptible granule is dimensionally formed and coated with a material that promotes wetting within such a conducting fluid. Typically a MSCS is comprised of a conducting liquid and a solid granule however emulsions are also a viable composition descriptor.

At present the most efficient conducting liquids that act to transport, reflect, and spallate elementary particles and compounds as found in physics are liquid metals. A form of fluid that could qualify as a conducting fluid includes Deuterium doped with a salt. The best examples of conducting fluids are gallium and mercury in liquid forms. Such conducting fluids exposed to high energy particle beams will experience a spallation event forming elemental isotopes as the result of impact by accelerated neutron or proton. A typical spallation event includes addition or reduction of the nucleus with electron flux of free and transported electrons through a volume of MSCS.

A MSCS may contain different types of magnetically susceptible granules. Such granules are susceptible to normal magnetic fields produced by ferro magnets, rare earth magnets having a field of 1.5 T and may act within higher superconducting fields. These granules are manufactured to account for variables such as granule size, buoyancy and wetting material for mating with a conducting fluid. It is desirable to have granules that are themselves capable of conduction and transportation with composite materials that can withstand spallation events. As it is not the intent of this invention to limit the type of magnetically susceptible granule, the absolute value of magnetic susceptibility is discussed for all materials and must be statistically significant. Materials that are magnetically susceptible include paramagnetic, diamagnetic and ferromagnetic substance. Subcategories in part include lanthanides, actinides, iron and iron oxides. Accordingly, density averaging a granule to match a conducting fluid's density will optimize granule buoyancy as described by Archimedes principals. Density averaging magnetic material involves a counter weighing of light granule with a dense material that exceeds that of the fluid material density. Dense materials require formation of cavities filled with vacuum or lighter material to increase buoyancy within a conducting fluid. Tuning the size and average density of each granule type will produce a predictable material that has a known response to external forces and impulses such as momentum, electricity, magnetism and gravity. A highly responsive, lightweight granule will move rapidly while a heavy weight particle will have a slower response.

Within a slurry forces such as granule ring currents, magnetic field lines and Lorentz forces are present. These factors can be optimized to manipulate granules within a volume of MSCS such that plural, conjoined, three dimensional volumes are formed. These factors and others contribute to controlling the saltatory transport of granules induced by MHD movement in slurry. MHD flow of granules and adhered conductive fluid occurs along magnetic field lines. In regions populated with static granules ring currents external fields and granule field lines will alter both localization and movement of granules through a volume of MSCS. During electron flow Lorentz forces impart additional magnetic vectors that the granules respond to thereby effecting granule movement.

Encapsulation of magnetically susceptible granules prevents aggregation of magnetic granules within a MSCS by distance. This is a particular concern with actinides that may aggregate to critical nuclear mass. Aggregation may be limited by controlling granule magnetic field lines to prevent interaction and limit interaction by distance in this respect. A thin layer of encapsulating material would allow higher field interaction while a thicker layer might prevent all field lines from interacting. Encapsulation may take many forms, from volume centered to dimensional internal patterning. Internal patterning is desirable for addition of internal shielding patterns within granules. Patterns can be used to alter and remove field lines thereby promoting or inhibiting certain interactions to account for granule ring currents. A reproducible algorithm or fractal such as the Menger sponge or Sierpinski carpet with Koch recursion forms internal three dimensional patterns of granules by mixed materials to alter magnetic field lines and conduction through a volume of MSCS. Integrating these types of three dimensional patterns allow for a powerful method of external control of granule orientation and localization by magnetic field.

The size shape and design of granules depends upon conductor requirements such as inertial response time, device design and secondary or tertiary utility. The size may range from mesoscopic to macroscopic depending upon circuit forming or device design. Granules themselves may also act by conduction, transportation, reflection or spallation, thereby contributing to properties of a MSCS. The shape of the grains may include simple and compound volumes such as polyhedra, cube, great dodecahedron, parallelepiped, octagonal prism, disc, bead, sphere, hypersphere, blob, glossa, toroid, pentagonal prism, flagellum, dumbbell, egg shaped, bar, Klein bottle, dot, tittle, saddle, pinned, cones, stellated dodecahedron, diamond, needle, pear, elliptic cylinder, ovular and pyramid. A compound volume may include a Klein bottle with a flagellum for directional motility using an insulated bearing and elementary particle sensitive motor.

Surface patterning using a wetting material can produce fully or partially wet granules. A fully wet material provides adhesive forces between the granule and fluid that exceed the fluid to fluid cohesive forces thereby increasing wetting capacity. Partially wet dumbbells or rods will exhibit properties similar to amphiphilic organic compound and can be used to create a shielded core conductor. A surface material that promotes wetting of both mercury and gallium includes gold where plated surfaces will adhere the fluids. A partial surface patterning of a buoyant, cylindrically shaped light weight granule will result in the wet side being submerged, while the remainder floats above the surface. Small quantities of insulators added to a cylindrical volume of MSCS as shown in the drawing would result in an annularly centered insulating structure around the conducting core that extends above the conducting fluid surface with additional material contributing to a flexible sheathing layer.

The use of semiconductor devices within a fluid slurry imparts a significant improvement. The form of the semiconductor may be fully formed or self assembling. Granules are typically conducting members, insulating and other non-linear conducting members within a three dimensional volume of MSCS. A simple PN diode formed from phosphorous doped germanium mated to a boron doped silicon provides an inline rectifier while adding orienting capabilities incorporates directional control of particles. A simple device such as a transistor in granule form spanning multiple volumes will gate and control electrical current when correctly linked. Alternating conducting and computational elements provides a means of fabricating inline integrated circuits. These types of granules require insulating members and conducting electrodes, buoyancy compensation, encapsulation and patterned wetting materials. Semiconductor devices may take any shape and form as discussed where grains shaped as cubes with integrated circuits impart algorithms and methodologies such as Huo Wang dominoes, Roger Penrose tiles and Raphael Robinson shapes to vary conducting path. Additional voltage and current regulation by semiconductor devices is simplified using combinations of periodic and aperiodic granule type with orienting capacity. This further increases utility though localization, orientation and control of linear and non-linear conducting pathways.

When a conducting fluid is mixed with magnetically susceptible granules a MSCS is formed and a properly proportioned slurry may be shaped through a substrate such as a wax paper or a fiberglass circuit board. Formation of complex three dimensional shapes by adding multiple layers of liquid MSCS to frozen MSCS is a viable means of forming functional circuitry.

### Example

An example of a conducting MSCS composition and a manufacturing process thereof is disclosed:

A gold clad ferrous granule is immersed within the conducting liquid element mercury. Manufacture of granules is performed using a solid ferromagnetic wire rolled bead of 120 mesh having an approximate density of 7.87 grams per cubic centimeter. Granules are coated with a layer of copper having a density of 8.94 grams per cubic centimeter and then a subsequent coating of gold having a density of 19 grams per cubic centimeter to form an approximate grain with composite density of 13.54 grams per cubic centimeter having an approximate diameter of 0.21 millimeters. During encapsulation intermediate processing by geological sieving to final mesh allows one to select grains with the required diameter. Encapsulation is performed by coating ferrous granules in a series of electroplatings of copper and then gold on a flat electrode lining the bottom of an ultrasonic bath backed with a dielectric plastic sheet. Ultrasonic agitation during the coating process prevents adhesion to the plating electrode and also prevents caking or fusing of granules. When the magnetically susceptible granules are added to liquid mercury 13.54 grams per cubic centimeter they are neutrally buoyant and readily mix with mercury to wet the gold granule. As the entire surface of the encapsulated granule is coated, the gold to mercury adhesive force is greater than the mercury to mercury fluid cohesive forces and the process of a wetting a conductive fluid to the granule is complete. By comparison, copper clad ferrous granules do not readily wet nor mix and float to the surface of a volume of mercury. During mixing defective granules float above the surface plane of the mercury and may be removed into a container backed with a magnet. This MSCS may be magnetically formed between poles and through containers. If maintained at a temperature below 234.32 degrees Kelvin as is found in the shady space behind earth the MSCS freezes and holds shape as a solid. When subjected to an electrical voltage gradient a Hall effect is formed between two terminals. At standard temperature and pressure mercury in fluid form tends to flow along the conductor and cools the magnetically susceptible solid granules by convection. When placed in a dielectric oil the MSCS is capable of increased performance as a conductor with electrical shielding. This MSCS reflects photons generated by a 650 nm, 5 milliwatt hand-held laser pointer along the surface. If exposed to a proton or neutron beam as produced by a supercollider, this same material will spall neutrons, electron flux will increase and various isotopes of mercury and gold are produced. The spheres in this MSCS contribute to the viscosity as a whole by a function of five halves of the total volume fraction multiplied by the original viscosity. The total viscosity is simply the sum of the original fluid viscosity and the contributing viscosity of the spheres, excluding higher order terms for a dispersion or slurry.

1: A magnetically susceptible conductive slurry (MSCS) is used in a single or combination of methods thereof for conduction, transportation, reflection and spallation of elementary particles and or composite particles as described by chemistry and physics. A MSCS can be shape formed between magnetic poles, by magnetic force or magnetic impulse to form volumetric patterns. If desired during magnetic forming and reforming a MSCS may be frozen to hold shape. A MSCS has indefinite singular or plural volumes in part or in whole and may have continuous, discontinuous or shared boundary layer conditions as described geometrically or volumetrically. A MSCS is comprised of:
a) a conducting fluid that is capable of conduction, transportation, reflection or spallation of elementary particles and composite particles as described by chemistry and physics and that said fluid normally has a negligible absolute value of magnetic susceptibility.
b) granules that have a significant absolute value of magnetic susceptibility and are of indefinite shape and scale. Said granules have an external surface material in part or in whole, patterned to increase adhesive forces imparting wetting with the conducting fluid to said pattern. Magnetically susceptible granules have volumetric material and formed properties that optimize average volumetric density for control of buoyancy and inertial forces when combined with a conducting fluid.

2: A MSCS of indefinite volume described in claim 1 comprised of magnetically susceptible granules that are shaped, laminated or internally patterned for the purposes of spatial localization and orientation.

3: A MSCS of indefinite volume described in claim 1 comprised of magnetically susceptible granules and which are comprised of materials used to insulate, reflect or shield volumes in part or in whole from one or more elementary particles or composite particles.

4: A MSCS of indefinite volume described in claim 1 comprised of granules that alter viscosity of the composition.

5: A MSCS of indefinite volume described in claim 1 comprised of magnetically susceptible granules used to generate linear or non-linear response, where volumes of granules are themselves self-assembling semiconductor devices or formed semiconductor devices.

6: A MSCS of indefinite volume described in claim 1 comprised of granules having a material composition of an isotope that can be transmuted into an actinide or isotope thereof.

7: A MSCS of indefinite volume described in claim 1 comprised of granules patterned using a mathematical algorithm or fractal geometry by mixed materials.
